(19) United States
(12) Patent Application Publication
(10) Pub. No.: US 2016/0103201 A1
(43) Pub. Date: Apr. 14, 2016

(54) INDOOR POSITIONING SYSTEM, POSITIONING SERVER, AND INDOOR POSITIONING METHOD

(71) Applicant: WISTRON CORPORATION, New Taipei City (TW)

(72) Inventor: Hsu-Ming Lee, New Taipei City (TW)

(21) Appl. No.: 14/615,476

(22) Filed: Feb. 6, 2015

(30) Foreign Application Priority Data
Oct. 9, 2014 (TW) 103135151

(51) Int. Cl. G01S 5/12

(52) U.S. Cl. CPC G01S 5/12

(57) ABSTRACT

An indoor positioning system, a positioning server and an indoor positioning method are provided. The indoor positioning system is applied to detecting a position of a portable device in an indoor environment. The positioning system includes a first wireless detector, a second wireless detector, a third wireless detector and a positioning server. The first, the second and the third wireless detectors are in communication with the portable device. The first wireless detector and the second wireless detector respectively generates first wireless detecting information and second wireless detecting information corresponding to the portable device through a first wireless communication standard and a second wireless communication standard. The third wireless detector generates third wireless detecting information corresponding to the portable device. The positioning server retrieves the position of the portable device in the indoor environment according to the first, the second, and the third wireless detecting information.

This application claims the benefit of Taiwan application Serial No. 103135151, filed Oct. 9, 2014, the subject matter of which is incorporated herein by reference.

### BACKGROUND OF THE INVENTION

1. Field of the Invention

The invention relates in general to an indoor positioning system, a positioning server and an indoor positioning method, and more particularly to an indoor positioning system, a positioning server and an indoor positioning method for positioning a portable device in conjunction with heterogeneous wireless communication standards.

2. Description of the Related Art

In the past, the function of positioning a portable device (for example, mobile phone, tablet computer or the like) through the global positioning system (GPS) has already become very common. The GPS is originally designed to be used by the user having the open sky. When the GPS is used for the indoor positioning, satellite signals tend to be interfered by the building, thereby disabling the GPS from being applied and extended to the indoor environment. Thus, how to position the portable device in the indoor environment is an issue to be solved.

### SUMMARY OF THE INVENTION

The invention is directed to an indoor positioning system, a positioning server and an indoor positioning method, and more particularly to an indoor positioning system, a positioning server and an indoor positioning method using heterogeneous wireless communication standards.

According to a first aspect of the present invention, an indoor positioning system applied to detecting a position of a portable device in an indoor environment is provided. The indoor positioning system includes a first wireless detector, a second wireless detector, a third wireless detector, and a positioning server. The first wireless detector, the second wireless detector, and the third wireless detector are disposed in the indoor environment. The first wireless detector is in communication with the portable device through a first wireless communication standard, for generating first wireless detecting information corresponding to the portable device. The second wireless detector is in communication with the portable device through a second wireless communication standard, for generating second wireless detecting information corresponding to the portable device. The third wireless detector generates third wireless detecting information corresponding to the portable device. The positioning server is in communication with the first, the second, and the third wireless detectors for receiving the first wireless detecting information, the second wireless detecting information, and the third wireless detecting information. The positioning server retrieves the position of the portable device in the indoor environment according to the first, the second, and the third wireless detecting information.

According to a second aspect of the present invention, a positioning server for positioning a portable device in an indoor environment is provided. The positioning server includes a receiver and a database. The receiver is in communication with a network, for receiving first wireless detecting information, second wireless detecting information and third wireless detecting information corresponding to the portable device through the network. The database is electrically connected to the receiver, for storing a first detecting range corresponding to a first wireless detector, a second detecting range corresponding to a second wireless detector and a third detecting range corresponding to a third wireless detector. The positioning server retrieves a position of the portable device in the indoor environment according to the first, the second, and the third wireless detecting information and the first, the second, and the third detecting ranges.

According to a third aspect of the present invention, an indoor positioning method applied to detecting a position of a portable device in an indoor environment is provided. The indoor positioning method includes following steps. Firstly, a signal connection between a first wireless detector and the portable device is established through a first wireless communication standard, and first wireless detecting information corresponding to the portable device is generated by the first wireless detector according to the first wireless communication standard. Secondly, a signal connection between a second wireless detector and the portable device is established through a second wireless communication standard and second wireless detecting information corresponding to the portable device is generated by the second wireless detector according to the second wireless communication standard. Thirdly, third wireless detecting information corresponding to the portable device is generated by a third wireless detector. Furthermore, the position of the portable device in the indoor environment is retrieved according to the first wireless detecting information, the second wireless detecting information, and the third wireless detecting information.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic view showing that heterogeneous wireless detectors are disposed and used to detect a position of a portable device in an indoor positioning system of the invention.

FIG. 2 is a schematic view showing the indoor positioning system of the invention.

FIG. 3 is a flow chart showing an indoor positioning method of the invention.

### DETAILED DESCRIPTION OF THE INVENTION

In order to improve the drawback of the conventional positioning system, the invention provides the technology of positioning an indoor portable device in conjunction with heterogeneous wireless communication standards.

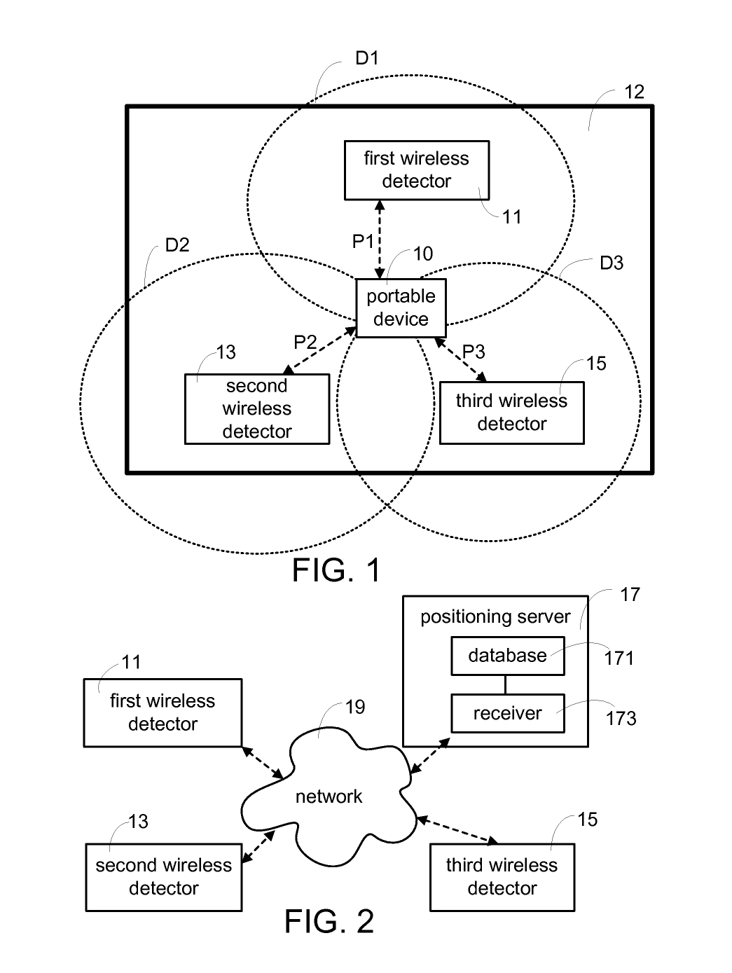

FIG. 1 is a schematic view showing that heterogeneous wireless detectors are disposed and used to detect a position of a portable device 10 in an indoor positioning system of the invention. Referring to FIG. 1, the portable device 10 can be arbitrarily moved in the indoor environment. According to the embodiment of the idea of the invention, at least two types of wireless communication standards are adopted for the signal connections between a first wireless detector 11, a second wireless detector 13, a third wireless detector 15 and the portable device 10.

For example, the first wireless detector 11 and the second wireless detector 13 are WiFi access points for detecting the portable device 10 through WiFi, and the third wireless detector is a low energy Bluetooth (iBeacon) detector for detecting the portable device 10 through iBeacon. Furthermore, another example is, the first wireless detector 11 and the portable device 10 establish a WiFi signal connection; the second wireless detector 13 and the portable device 10 establish a Zigbee signal connection; and the third wireless detector 15 is an iBeacon detector for detecting the portable device 10 through iBeacon.

Different types of wireless communication standards have different coverage. Taking WiFi as an example, the WiFi adopting 802.11b or 802.11g has the coverage reaching indoor—50 square meters (538 feet)/outdoor—140 square meters (1,500 feet) under no obstruction, and the WiFi adopting 802.11n has the further coverage. Next, taking iBeacon as an example, the iBeacon wireless detector can detect the farthest transmission distance of 50 m. Taking the near-field communication (NFC) as an example, the NFC is a short-distance high-frequency (13.56 MHz) wireless communication standard. The NFC wireless detector can be used in the portable device within the distance shorter than or equal to 20 centimeters. In addition to WiFi, iBeacon and NFC, detectors with the other wireless communication standards, such as ZigBee, Bluetooth and the like, may also be applied to the indoor positioning system of the invention.

According to the idea of the invention, the coverage that can be supported by the wireless communication standards may be represented by the circles of FIG. 1. Of course, with the differences between the arrangements in the indoor environment and the building's materials, the detecting ranges corresponding to the wireless detectors are not necessarily to be symmetrically circular.

Different wireless detectors of different wireless communication standards correspond to different sizes of the detecting ranges. For example, the detecting range of the iBeacon wireless detector is larger than the detecting range of the NFC wireless detector, and this represents that the radius of the circle with the iBeacon wireless detector serving as the center is larger than the radius of the circle with the NFC wireless detector serving as the center.

According to the idea of the invention, the first wireless detector 11 can detect whether there is any device using the first wireless communication standard in a first detecting range D1. In other words, if the portable device 10 is moved to another position still in the first detecting range D1, the first wireless detector 11 can correspondingly generate first wireless detecting information corresponding to the portable device 10. Similarly, the second wireless detector 13 can detect whether there is any device using the second wireless communication standard in a second detecting range D2. The third wireless detector 15 can detect whether there is any device using the third wireless communication standard in a third detecting range D3.

By comparing the wireless detecting information generated by the wireless detectors, the indoor positioning system can approximately estimate an actual position of the portable device. For example, when the first wireless detector 11 and the second wireless detector 13 generate the first wireless detecting information and the second wireless detecting information corresponding to the portable device 10, respectively, it represents that the portable device 10 is positioned in an overlapped region between the first detecting range D1 and the second detecting range D2.

Similarly, if the first wireless detector 11, the second wireless detector 13 and the third wireless detector 15 generate the first wireless detecting information, the second wireless detecting information and the third wireless detecting information corresponding to the portable device 10, it represents that the portable device 10 is positioned in the first detecting range D1, the second detecting range D2 and the third detecting range D3 overlapped region. The portable device 10 of FIG. 1 is positioned in an overlapped region among the first detecting range D1, the second detecting range D2 and the third detecting range D3.

For the sake of following description, it is assumed that the first wireless detector 11, the second wireless detector 13 and the third wireless detector 15 are in communication with to the portable device 10 through three different types of the wireless communication standards. In other words, the first wireless detector 11 is in communication with the portable device 10 through the first wireless communication standard P1 (for example, WiFi); the second wireless detector 13 is in communication with the portable device 10 through the second wireless communication standard P2 (for example, Zigbee); and the third wireless detector 15 is in communication with the portable device 10 through the third wireless communication standard P3 (for example, iBeacon).

FIG. 2 is a schematic view showing the indoor positioning system of the invention. Referring to FIG. 2, a positioning server 17 is in communication with the first wireless detector 11, the second wireless detector 13 and the third wireless detector 15 through a network 19.

The positioning server 17 includes a receiver 173 and a database 171. The receiver 173 is in communication with the network 19, and receives the wireless detecting information, corresponding to the portable device, through the network 19. The database 171 is electrically connected to the receiver 173. The information associated with the wireless detector is stored in the database 171 in advance. For example, the first detecting range corresponds to the first wireless detector 11, the second detecting range corresponds to the second wireless detector 13, and the third detecting range corresponds to the third wireless detector 15. Thus, the positioning server 17 can retrieve the position of the portable device 10 in an indoor environment 12 according to the wireless detecting information and the detecting ranges.

When the first wireless detector 11 detects the portable device 10 through the first wireless communication standard P1, the first wireless detector 11 generates the first wireless detecting information. After the first wireless detector 11 generates the first wireless detecting information, the first wireless detector 11 transmits the first wireless detecting information to the positioning server 17 through the network 19.

When the second wireless detector 13 detects the portable device 10 through the second wireless communication standard P2, the second wireless detector 13 generates the second wireless detecting information. After the second wireless detector 13 generates the second wireless detecting information, the second wireless detector 13 transmits the second wireless detecting information to the positioning server 17 through the network 19.

When the third wireless detector 15 detects the portable device 10 through the third wireless communication standard P3, the third wireless detector 15 generates the third wireless detecting information. After the third wireless detector 15 generates the third wireless detecting information, the third wireless detector 15 transmits the third wireless detecting information to the positioning server 17 through the network 19.

After the positioning server 17 receives the first wireless detecting information, the second wireless detecting information and the third wireless detecting information from the network 19, the positioning server 17 further works in conjunction with the positioning algorithm to estimate the position of the portable device. The type of the positioning algorithm needs not to be restricted. For example, the positioning server 17 may adopt the triangulation algorithm, the circle intersection point algorithm or the like.

With the change of the position of the portable device 10 in the indoor environment, the wireless detector applied to detection of the portable device may be changed. For example, it is assumed that the indoor positioning system further includes a fourth wireless detector (not shown) corresponding to a fourth detecting range D4. If the portable device 10 leaves the third detecting range D3 and is then moved to the intersection portion of the first detecting range D1, the second detecting range D2 and the fourth detecting range D4, then the positioning server 17 switches to receive the wireless detecting information through the first wireless detector 11, the second wireless detector 13 and the fourth wireless detector, and thus determines that the retrieved new position of the portable device 10 is at the intersection portion of the first detecting range D1, the second detecting range D2 and the fourth detecting range D4.

In other words, if the wireless detector detects the presence of the portable device 10 according to the wireless communication standard adopted thereby, then the wireless detector correspondingly generates and transmits the wireless detecting information, corresponding to the portable device 10, to the positioning server 17. On the contrary, if the wireless detector does not detect the presence of the portable device 10 according to the wireless communication standard adopted thereby, then the wireless detector does not generate nor transmit the wireless detecting information, corresponding to the portable device 10, to the positioning server 17. Incidentally, the positioning server 17 can approximately determine the actual position of the portable device 10 according to which wireless detectors transmits the wireless detecting information, and the internally stored mounting positions of the wireless detectors and the corresponding detecting ranges.

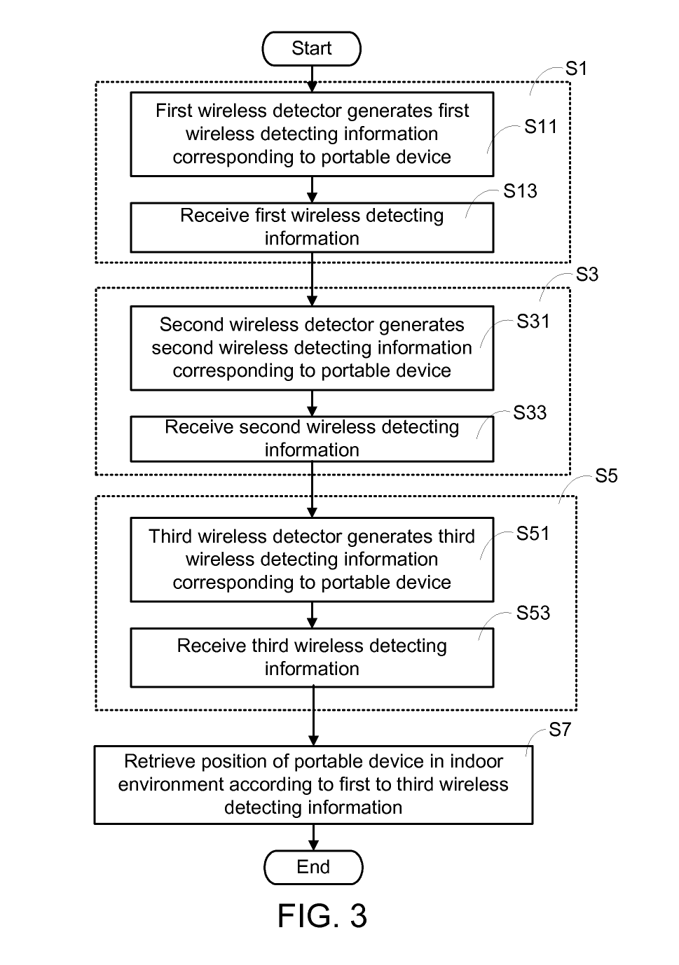

FIG. 3 is a flow chart showing an indoor positioning method of the invention. Referring to FIG. 3, steps S1, S3 and S5 represent the steps, in which each wireless detector generates the wireless detecting information after the portable device 10 is moved to the detecting range of each wireless detector, and the positioning server 17 receives the wireless detecting information. It is to be noted that the order of the steps S1, S3 and S5 is not restricted thereto, and the steps S1, S3 and S5 may even be performed in parallel.

In the step S1, the first wireless detector 11 generates the first wireless detecting information corresponding to the portable device according to the first wireless communication standard (step S11). Next, the first wireless detector 11 transmits the first wireless detecting information to the positioning server 17 through the network 19. In other words, the positioning server 17 receives the first wireless detecting information through the network 19 (step S13).

In the step S3, the second wireless detector 13 generates the second wireless detecting information corresponding to the portable device 10 according to the second wireless communication standard (step S31). Next, the second wireless detector 13 transmits the second wireless detecting information to the positioning server 17 through the network. In other words, the positioning server 17 receives the second wireless detecting information through the network 19 (step S33).

In the step S5, the third wireless detector 15 generates the third wireless detecting information corresponding to the portable device 10 according to the third wireless communication standard (step S51). Next, the third wireless detector 15 transmits the third wireless detecting information to the positioning server 17 through the network 19. In other words, the positioning server 17 receives the third wireless detecting information through the network 19 (step S53).

Thereafter, the positioning server 17 further works in conjunction with various positioning algorithms to retrieve the position of the portable device in the indoor environment according to the first wireless detecting information, the second wireless detecting information and the third wireless detecting information (step S7).

As mentioned hereinabove, the positioning server 17 utilizes the database 171 to store the information associated with the wireless detector. In the following table, the numbers of the actually stored wireless detectors and the information types in the database 171 are only for the illustrative but non-restrictive purpose.

| | | Wireless | |
|---|---|---|---|
| Wireless | | communication | |
| detector | Mounting position | standard | Detecting range |
| first wireless | first mounting | WiFi | WiFi detecting |
| detector | position | | range |
| second wireless | second mounting | Zigbee | ZigBee detecting |
| detector | position | | range |
| third wireless | third mounting | iBeacon | iBeacon detecting |
| detector | position | | range |

The database 173 stores the mounting position of each wireless detector, the adopted wireless communication standard of each wireless detector, and the detecting range corresponding to each wireless detector. If the above-mentioned example is extended, then the first wireless detector 11 is the WiFi wireless detector mounted at the first mounting position, the wireless communication standard corresponding to the first wireless detector 11 is WiFi, and the first detecting range D1 corresponds to the WiFi detecting range; the second wireless detector 13 is the Zigbee wireless detector mounted at the second mounting position, the wireless communication standard corresponding to the second wireless detector 13 is Zigbee, and the second detecting range D2 corresponds to the Zigbee detecting range; and the third wireless detector 15 is the iBeacon wireless detector mounted at the third mounting position, the wireless communication standard corresponding to the third wireless detector 15 is iBeacon, and the third detecting range D3 corresponds to the iBeacon detecting range.

According to the descriptions, it is obtained that the indoor positioning system of the invention can work in conjunction with various existing wireless communication standards of the indoor environment to detect and generate the wireless detecting information of the portable device 10 from different wireless detectors. Then, the remote positioning server 17 is used to receive and combine the wireless detecting information generated by the wireless detectors, and determine the position of the portable device according to the wireless detecting information. Thus, the indoor positioning method of the invention does not need the provision of the dedicated wireless detector, and can save the manufacturing cost of the indoor positioning system.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An indoor positioning system applied to detecting a position of a portable device in an indoor environment, the indoor positioning system comprising:
a first wireless detector, disposed in the indoor environment, in communication with the portable device through a first wireless communication standard, for generating first wireless detecting information corresponding to the portable device;
a second wireless detector, disposed in the indoor environment, in communication with the portable device through a second wireless communication standard, for generating second wireless detecting information corresponding to the portable device;
a third wireless detector, disposed in the indoor environment, for generating third wireless detecting information corresponding to the portable device; and
a positioning server, in communication with the first, the third, and the third wireless detectors, for receiving the first wireless detecting information, the second wireless detecting information, and the third wireless detecting information and accordingly retrieving the position of the portable device in the indoor environment.

2. The indoor positioning system according to claim 1, wherein the positioning server is in communication with the first, the second and the third wireless detectors through a network.

3. The indoor positioning system according to claim 1, wherein the positioning server retrieves the position of the portable device in the indoor environment according to the first, the second, and the third wireless detecting information and a positioning algorithm.

4. The indoor positioning system according to claim 3, wherein the positioning algorithm is a triangulation algorithm or a circle intersection point algorithm.

5. The indoor positioning system according to claim 1, wherein the third wireless detector is in communication with the portable device through a third wireless communication standard, and generates the third wireless detecting information.

6. The indoor positioning system according to claim 5, wherein the first wireless communication standard, the second wireless communication standard, and the third wireless communication standard are heterogeneous wireless communication standards.

7. The indoor positioning system according to claim 1, wherein the third wireless detector detects the third wireless detecting information through one of the first wireless communication standard and the second wireless communication standard.

8. The indoor positioning system according to claim 1, wherein each of the first, the second, and the third wireless communication standards is a wireless local area network standard (WiFi), Zigbee, near field communication (NFC), Bluetooth or low energy Bluetooth (iBeacon).

9. A positioning server for determining a position of a portable device in an indoor environment, the positioning server comprising:
a receiver, in communication with a network, for receiving first wireless detecting information, second wireless detecting information and third wireless detecting information corresponding to the portable device through the network; and
a database, electrically connected to the receiver, for storing a first detecting range corresponding to a first wireless detector, a second detecting range corresponding to a second wireless detector and a third detecting range corresponding to a third wireless detector, wherein the positioning server retrieves the position of the portable device in the indoor environment according to the first, the second, and the third wireless detecting information and the first, the second, and the third detecting ranges.

10. The positioning server according to claim 9, wherein:
the first wireless detecting information is generated by the first wireless detector and transmitted to the network;
the second wireless detecting information is generated by the second wireless detector and transmitted to the network; and
the third wireless detecting information is generated by the third wireless detector and transmitted to the network.

11. The positioning server according to claim 10, wherein
the first wireless detector establishes a signal connection to the portable device according to a first wireless communication standard, and generates the first wireless detecting information according to the first wireless communication standard; and
the second wireless detector establishes another signal connection to the portable device according to a second wireless communication standard, and generates the second wireless detecting information according to the second wireless communication standard.

12. An indoor positioning method applied to an indoor positioning system, the indoor positioning method comprising the steps of:
establishing a signal connection to a portable device in an indoor environment through a first wireless communication standard, and accordingly generating first wireless detecting information corresponding to the portable device;
establishing another signal connection to the portable device through a second wireless communication standard, and accordingly generating second wireless detecting information corresponding to the portable device;
generating third wireless detecting information corresponding to the portable device; and
retrieving a position of the portable device in the indoor environment according to the first wireless detecting information, the second wireless detecting information, the third wireless detecting information and a positioning algorithm.

13. The method according to claim 12, wherein the step of generating the third wireless detecting information corresponding to the portable device comprises:
establishing yet another signal connection to the portable device through a third wireless communication standard, and accordingly generating the third wireless detecting information.

14. The method according to claim 13, wherein the first wireless communication standard, the second wireless communication standard, and the third wireless communication standard are heterogeneous wireless communication standards.

15. The method according to claim 12, wherein the step of generating the third wireless detecting information corresponding to the portable device comprises:
establishing still another signal connection to the portable device through one of the first wireless communication standard and the second wireless communication standard, and accordingly generating the third wireless detecting information.
